(19) United States
(12) Patent Application Publication
(10) Pub. No.: US 2026/0134428 A1
(43) Pub. Date: May 14, 2026

(54) SYSTEM AND METHOD FOR LEVERAGING A DISTRIBUTED NETWORK SYSTEM FOR SECURE DATA TRANSFERS

(71) Applicant: BANK OF AMERICA CORPORATION, Charlotte, NC (US)

(72) Inventors: Pratap Dande, Saint Johns, FL (US); Tony Aidoo, Aubrey, TX (US); Noell Y. Eury, Stanfield, NC (US); Brian Jacobson, Granada Hills, CA (US); Dennis Vranjesevic, Kent Cliffs, NY (US); Rahul Yaksh, Austin, TX (US); Bojan Zdravkovic, Jersey City, NJ (US)

(73) Assignee: BANK OF AMERICA CORPORATION, Charlotte, NC (US)

(21) Appl. No.: 18/944,507

(22) Filed: Nov. 12, 2024

(51) Int. Cl. G06Q 20/40; G06Q 20/02

(52) U.S. Cl. CPC G06Q 20/4014; G06Q 20/02

(57) ABSTRACT

Systems, computer program products, and methods are described herein for leveraging a distributed network system for secure data transfers. The present disclosure is configured to receive a data transfer from an entity where the entity is at least partially implicated within the data transfer, where the data transfer comprises participants; record the data transfer within a distributed network system, where the distributed network system comprises previous data transfers; verify identities of participants associated with the data transfer; and trigger the data transfer between participants.

### TECHNOLOGICAL FIELD

Example embodiments of the present disclosure relate to leveraging a distributed network system for secure data transfers.

### BACKGROUND

Recording and tracking data transfers across regulatory lines has been burdensome for participants within the data transfer as well as entities associated with the data transfer.

Applicant has identified a number of deficiencies and problems associated with leveraging a distributed network system for secure data transfers. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for leveraging a distributed network system for secure data transfers. In one aspect, a system for leveraging a distributed network system for secure data transfers is provided. The system including a processing device, a non-transitory storage device containing instructions when executed by the processing device, causes the processing device to perform the steps of: receive a data transfer from an entity wherein the entity is at least partially implicated within the data transfer, wherein the data transfer comprises participants associated with the data transfer; record the data transfer within a distributed network system, wherein the distributed network system comprises previous data transfers; verify identities of participants associated with the data transfer; and trigger the data transfer between participants.

In some embodiments, the data transfer comprises a smart contract at least partially implicating participants associated with the data transfer.

In some embodiments, there are a plurality of participants associated with the data transfer.

In some embodiments, the data transfer occurs across a plurality of regulatory bodies.

In some embodiments, recording the data transfer within the distributed network system comprises identifiable information recorded into the distributed network system.

In some embodiments, participants associated with the data transfer are sourced from outside the entity.

In some embodiments, the data transfer comprises a resource transfer.

In another aspect, a computer program product for leveraging a distributed network system for secure data transfers is presented. The computer program product comprising at least one non-transitory computer-readable medium having computer-readable program code portions embodied therein, the computer-readable program code portions which when executed by a processing device are configured to cause the processor to perform the following operations: receive a data transfer from an entity wherein the entity is at least partially implicated within the data transfer, wherein the data transfer comprises participants associated with the data transfer; record the data transfer within a distributed network system, wherein the distributed network system comprises previous data transfers; verify identities of participants associated with the data transfer; and trigger the data transfer between participants.

In some embodiments, the data transfer comprises a smart contract at least partially implicating participants associated with the data transfer.

In some embodiments, there are a plurality of participants associated with the data transfer.

In some embodiments, the data transfer occurs across a plurality of regulatory bodies.

In some embodiments, recording the data transfer within the distributed network system comprises identifiable information recorded into the distributed network system.

In some embodiments, participants associated with the data transfer are sourced from outside the entity.

In some embodiments, the data transfer comprises a resource transfer.

In another aspect, a computer-implemented method for leveraging a distributed network system for secure data transfers is presented. The computer-implemented method comprising: receiving a data transfer from an entity wherein the entity is at least partially implicated within the data transfer, wherein the data transfer comprises participants associated with the data transfer; recording the data transfer within a distributed network system, wherein the distributed network system comprises previous data transfers; verifying identities of participants associated with the data transfer; and triggering the data transfer between participants.

In some embodiments, the data transfer comprises a smart contract at least partially implicating participants associated with the data transfer.

In some embodiments, there are a plurality of participants associated with the data transfer.

In some embodiments, the data transfer occurs across a plurality of regulatory bodies.

In some embodiments, recording the data transfer within the distributed network system comprises identifiable information recorded into the distributed network system.

In some embodiments, the data transfer comprises a resource transfer.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for leveraging a distributed network system for secure data transfers, in accordance with an embodiment of the disclosure;

FIGS. 2A-2B illustrate an exemplary distributed ledger technology (DLT) architecture, in accordance with an embodiment of the disclosure; and

FIG. 3 illustrates a process flow for leveraging a distributed network system for secure data transfers in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

Data transfers within an entity (e.g., a financial institution) may be conducted between a plurality of participants across multiple regulatory bodies. Verification of the participants associated with the data transfer may further be a prerequisite for the data transfer to occur. Verification, accountability, security, and speed at which a data transfer is conducted may affect the operations, security, and efficiency of the entity.

Reconciling trades across multiple accounts, markets, and settlement periods may be complex and time consuming. Additionally, structures for data transfers may be fragmented and utilize constant communication causing a plurality of issues and delays. Tracking financial processes such as supply chain financing, letters of credit, and invoice financing may decrease operational delays and difficulties encountered.

Distributed network technology (e.g., distributed ledger technology) may be implemented within resource transfers within an entity. Implementation of distributed network technology within data transfers including supply chain financing, letters of credit, and invoice financing may enhance security, tracking capabilities, and efficiency of data transfers within an entity. Documents associated with the data transfer may be automatically verified, improving security of the entity, and reducing time needed to process data transfers.

Accordingly, the present disclosure presents a system and method to leverage distributed network technology (e.g., distributed ledger technology) within an entity to consolidate, secure, and track data transfers (e.g., supply chain financing, letters of credit, and invoice financing). Upon receiving a data transfer from an entity at least partially implicated within the data transfer (e.g., a financial institution presiding over supply chain financial exchanges), the data transfer may be recorded within a distributed network system. The distributed network system may comprise previously completed data transfers (e.g., previous supply chain financial exchanges, letters of credit, and/or invoice financing documentation). Identities of participants associated with the data transfer may subsequently be verified and/or validated, which may trigger the data transfer to proceed between participants. In some embodiments, a smart contract (i.e., a self-executing contract) may be embedded within the data transfer. Data transfers may further be conducted across a plurality of regulatory bodies (e.g., multiple institutions, regulators, and governments), and sourced from outside the entity at least partially implicated within the data transfer.

What is more, the present disclosure provides a technical solution to a technical problem. As described herein, the technical problem includes tracking and securing data transfers (e.g., trade finance procedures) within institutions. The technical solution presented herein allows for leveraging a distributed network system for secure data transfers. In particular, leveraging a distributed network system for secure data transfers is an improvement over existing solutions to the tracking and securing data transfers within institutions, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

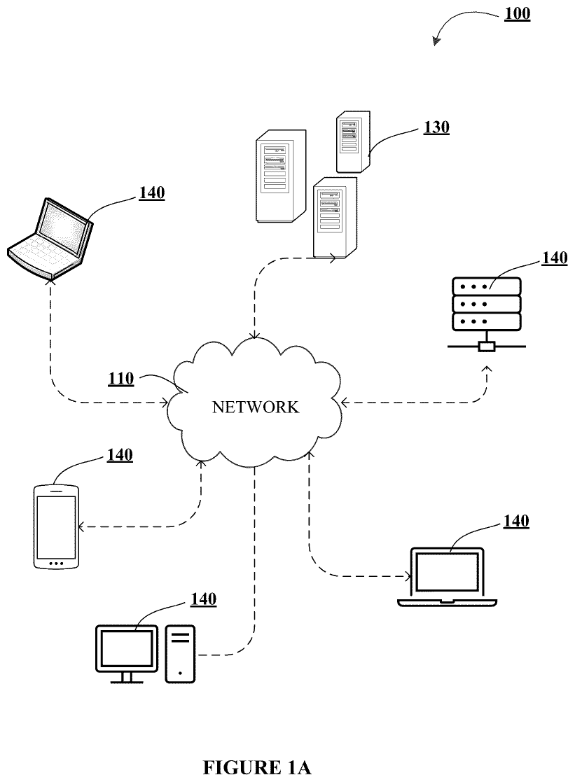

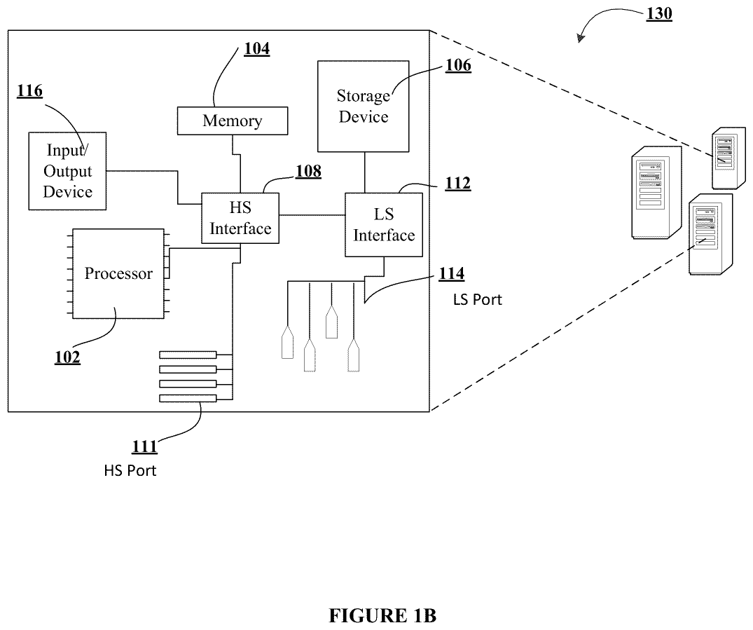

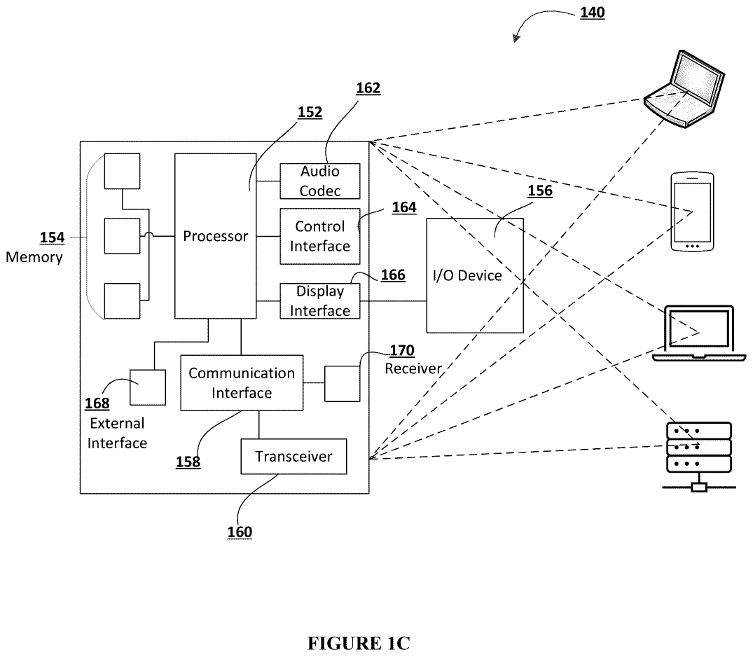

FIGS. 1A-1C illustrate technical components of an exemplary distributed computing environment for leveraging a distributed networks system for secure data transfers 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

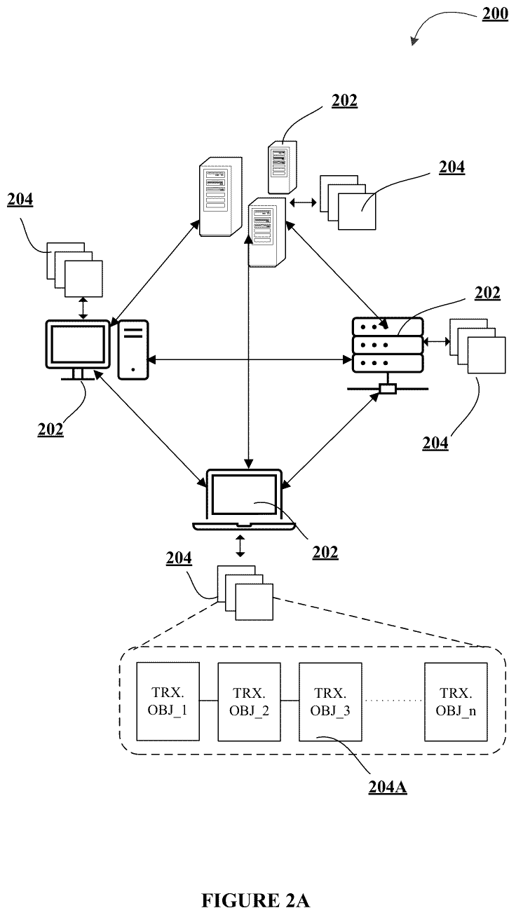

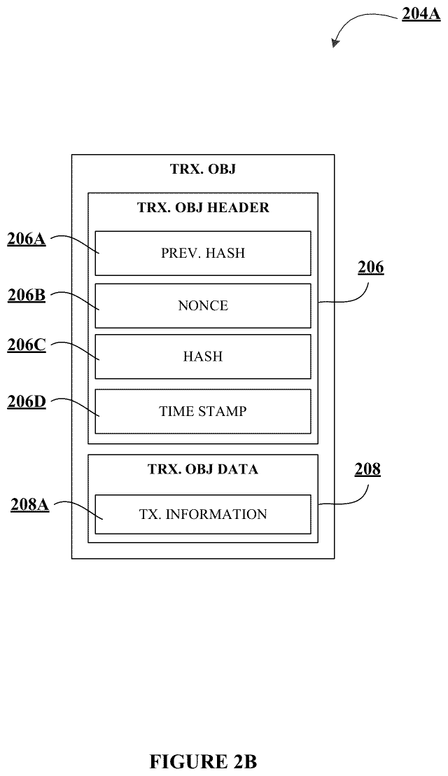

FIGS. 2A-2B illustrate an exemplary distributed ledger technology (DLT) architecture, in accordance with an embodiment of the invention. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 2A, the exemplary DLT architecture 200 includes a distributed ledger 204 being maintained on multiple devices (nodes) 202 that are authorized to keep track of the distributed ledger 204. For example, these nodes 202 may be computing devices such as system 130 and client device(s) 140. One node 202 in the DLT architecture 200 may have a complete or partial copy of the entire distributed ledger 204 or set of transactions and/or transaction objects 204A on the distributed ledger 204. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 2B, an exemplary transaction object 204A may include a transaction header 206 and a transaction object data 208. The transaction header 206 may include a cryptographic hash of the previous transaction object 206A, a nonce 206B—a randomly generated 32-bit whole number when the transaction object is created, cryptographic hash of the current transaction object 206C wedded to the nonce 206B, and a time stamp 206D. The transaction object data 208 may include transaction information 208A being recorded. Once the transaction object 204A is generated, the transaction information 208A is considered signed and forever tied to its nonce 206B and hash 206C. Once generated, the transaction object 204A is then deployed on the distributed ledger 204. At this time, a distributed ledger address is generated for the transaction object 204A, i.e., an indication of where it is located on the distributed ledger 204 and captured for recording purposes. Once deployed, the transaction information 208A is considered recorded in the distributed ledger 204.

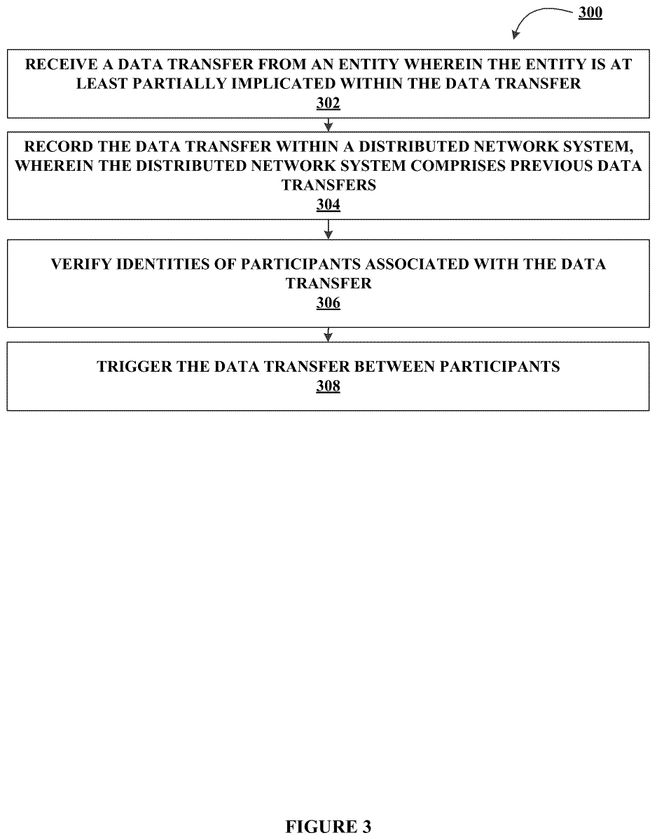

FIG. 3 illustrates a process flow for leveraging a distributed network system for secure data transfers. In some embodiments, a system (e.g., similar to one or more of the systems described herein with respect to FIGS. 1A-1C) and a form of distributed ledger technology (e.g., similar to one or more distributed ledger architecture subsystems described in FIGS. 2A-2B) may perform one or more of the steps of process flow 300.

As shown in Block 302, the process flow 300 may include the step of receiving a data transfer from an entity wherein the entity is at least partially implicated within the data transfer. A data transfer may comprise a resource transfer, resource allocation, data exchange, information transfer, and/or an agreement conducted between at least two participants. Participants within the data transfer may comprise entities, groups, individuals, conglomerates, and/or institutions interacting and/or engaging with the data transfer. The data transfer may further be implemented as or implemented within a distributed network system, as described within FIGS. 2A-2B. The data transfer may be implemented within an entity and/or institution, and may further be conducted with partners, associates, individuals, entity, and/or institution associated with the data transfer.

Receiving the data transfer from an entity may comprise allocating resources within the entity to a second individual, group, entity, institution, and/or combination of such. The entity may be at least partially implicated with the data transfer by participating in the data transfer directly and/or indirectly through an individual, group, and/or subsidiary. Partial implication of the entity within the data transfer may further be connected to the entity through a third party and/or external individual, group, and/or subsidiary. For instance, a data transfer between a first group and a second group may be conducted through a third-party service/and or software that connects to the entity, which may indicate partial implication of the entity. In another instance, an entity may be at least partially implicated with the data transfer via the terms and conditions of the data transfer. The entity may be any institution employing information technology resources and particularly technology infrastructure configured to for processing large amounts of data, as previously described.

In some embodiments, there are a plurality of participants associated with the data transfer. Participants associated with the data transfer may be individuals, groups, entities, and/or groups within and external to the entity at least partially implicated within the data transfer. For instance, a first group of participants associated with the data transfer may originate within the entity while a second group of participants may originate outside of the entity. The plurality of participants associated with the data transfer may comprise combinations of multiple groups, entities, and/or individuals that may be at least partially implicated within the data transfer.

In some embodiments, at least one participant (e.g., party, group, and/or individual) associated with the data transfer may be sourced from outside the entity. For instance, a data transfer may be received between a first group and a second group, with the second group comprising individuals representing a plurality of entities and external partners. The plurality of sources may comprise identities, verifiable information, authentication credentials, and/or indicia which may be used to verify and validate participants associated with the data transfer. In some embodiments, the data transfer may be halted, paused, cancelled, and/or designated to undergo further processing depending on the verification and validation status of participants associated with the data transfer.

In some embodiments, the data transfer may comprise at least one resource transfer. The resource transfer within the data transfer may be conducted through a distributed network system (e.g., the exemplary distributed ledger system as previously described within FIGS. 2A-2B). Resource transfers conducted may comprise letters of credit, invoice financing, share ledgers, and supply chain financial documents, agreements, and/or contractual obligations. For instance, a resource transfer in the form of a letter of credit may indicate, ensure, promise, and/or guarantee that a first party within the data transfer will receive promised resources pending the fulfillment of conditions filled prior to the resource transfer. The letter of credit may further comprise revocable, irrevocable, confirmed, and/or standby letters of credit. In another instance, data transfers in the form invoice financing may comprise a solution that utilizes outstanding invoices to access resources.

In some embodiments, the data transfer may verify documents associated with the data transfer. For instance, data transfers embodied as resource transfers, shared ledgers, invoice financing, letters of credit, and/or supply chain finance may comprise documents, agreements, contracts, and/or identification that may be documented, recorded, and/or inscribed within the data transfer, as described in greater detail below. Documents that may be verified, validated, and/or recorded within the data transfer may include but may not be limited to invoices, receipts, agreements, records, compliance documentation, shipping documents, certifications, customs documentation, amendment records, purchase orders, sales contracts, payment confirmation s, audit trails, and the like.

In some embodiments, at least one smart contract may be embedded within the data transfer. The at least one smart contract within the data transfer may be a self-executing contract (or multiple contracts) that may be automatically enforced upon predetermined conditions being met. For instance, a smart contract embedded within the data transfer may be implemented within the data transfer and activate during/after the data transfer has been conducted. A smart contract within the data transfer may, for instance, activate upon verification of participants associated with the data transfer. In another instance, the smart contract may activate based on predetermined conditions associated with the data transfer. Predetermined conditions in which the smart contract may be activated may include but may not be limited to completion of previous transfers, transfers occurring between approved participants/verified participants, completion of sub resource transfers, etc.

As shown in Block 304, the process flow 300 may include the step of recording the data transfer within a distributed network system, wherein the distributed network system comprises previous data transfers. The distributed network system may be embodied by the exemplary distributed network system described in FIGS. 2A-2B. Recording the data transfer within the distributed network system (e.g., blockchain technology) may comprise inscribing, writing, noting, and/or documenting the data transfer and participants of the data transfer. Previous data transfers may be recorded within the distributed ledger and may be accessed to reference previous data transfers. In some embodiments, the distributed ledger may reference previously recorded data transfers in smart contracts embedded within the data transfer. Previously recorded data transfers may be accessed as described in the exemplary distributed ledger system described within FIGS. 2A-2B.

In some embodiments, the data transfer may be conducted across a plurality of regulatory bodies. For instance, the data transfer may be conducted from the plurality of sources across multiple legislative jurisdictions, regulatory frameworks, compliance authorities, and the like. Adherence to the plurality of regulatory jurisdictions may be recorded within the distributed network system and/or the data transfer being conducted. The data transfer may be conducted and processed within the distributed network system in accordance with the plurality of regulatory bodies. For instance, a data transfer occurring within the regulations of a first country and finishing within the regulations of a second country may be recorded within the distributed network system. Regulations associated with both the first country and the second country and the adherence to the respective regulations may be recorded within the distributed network system.

In some embodiments, recording the data transfer within the distributed network system comprises identifiable information written into the distributed network system. Identifiable information may be information associated with the participants of the data transfer, information that may be used to verify participants associated with the data transfer, and/or identifiable information associated with the data transfer itself. Identifiable information may be recorded within the distributed network system during or after completion of the data transfer. For instance, identifiable information associated with a first participant may be recorded upon initialization of the data transfer, and identifiable information associated with a second participant may be recorded upon verification of the first participant.

In some embodiments, sub transfers within the data transfer may be recorded on the distributed network system. For instance, a data transfer in the form of a resource transfer may comprise sub transfers (e.g., brokerage structure transfers and sub resource transfers). Sub transfers within the transfer may be recorded within the data transfer, in addition to participants within the sub transfer.

As shown in Block 306, the process flow 300 may include the step of verifying identities of participants associated with the data transfer. Verification of the identities of the participants associated with the data transfer may be conducted through verification and validation of recorded documents within the distributed network system as previously described. In some embodiments, verification of identities may be conducted using authentication credentials, indicia, retrieval of documentation within the distributed network system, and/or adherence to a predetermined set of criteria. In some embodiments, verification of identities of participants associated with the data transfer may be conducted through the reception of authentication credentials associated with the participants. For instance, authentication credentials from a first group of participants may be received to validate and verify the identities of the first group while a second set of authentication credentials from a second group of participants may be received to verify and validate the identities of the second group.

As shown in Block 308, the process flow 300 may include the step of triggering the data transfer between participants. Triggering the data transfer may comprise executing the data transfer and/or signaling the data transfer may procced. For instance, the data transfer may be triggered upon recording of the data transfer within the distributed network system and verification of identities of participants associated with the data transfer. In another instance, recording and verification may be a prerequisite to complete the data transfer, in which failure to verify identities within the data transfer may pause, halt, and/or terminate the data transfer in process. Further, a data transfer that may have been paused, halted, and/or terminated may be recorded within the distributed network system.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for leveraging a distributed network system for secure data transfers, the system comprising:
a processing device;
a non-transitory storage device containing instructions when executed by the processing device, causes the processing device to perform the steps of:
receive a data transfer from an entity wherein the entity is at least partially implicated within the data transfer, wherein the data transfer comprises participants associated with the data transfer;
record the data transfer within a distributed network system, wherein the distributed network system comprises previous data transfers;
verify identities of participants associated with the data transfer by retrieving documents recorded within the distributed network system associated with previous data transfers and participants within the data transfer;
verify the data transfer complies with regulatory bodies associated with previously verified participants; and
trigger the data transfer between the participants upon successful verification of participants within the data transfer.

2. The system of claim 1, wherein the data transfer comprises a self-executing contract at least partially implicating participants associated with the data transfer.

3. The system of claim 1, wherein there are a plurality of participants associated with the data transfer.

4. The system of claim 1, wherein the data transfer occurs across a plurality of regulatory bodies.

5. The system of claim 1, wherein recording the data transfer within the distributed network system comprises identifiable information recorded into the distributed network system.

6. The system of claim 1, wherein at least one participant within the data transfer is sourced from outside the entity.

7. The system of claim 1, wherein the data transfer comprises a resource transfer.

8. A computer program product for leveraging a distributed network system for secure data transfers, the computer program product comprising at least one non-transitory computer-readable medium having computer-readable program code portions embodied therein, the computer-readable program code portions which when executed by a processing device are configured to cause a processor to perform the following operations:
receive a data transfer from an entity wherein the entity is at least partially implicated within the data transfer,
wherein the data transfer comprises participants associated with the data transfer;
record the data transfer within a distributed network system, wherein the distributed network system comprises previous data transfers;
verify identities of participants associated with the data transfer by retrieving documents recorded within the distributed network system associated with previous data transfers and participants within the data transfer;
verify the data transfer complies with regulatory bodies associated with previously verified participants; and
trigger the data transfer between the participants upon successful verification of participants within the data transfer.

9. The computer program product of claim 8, wherein the data transfer comprises a self-executing contract at least partially implicating participants associated with the data transfer.

10. The computer program product of claim 8, wherein there are a plurality of participants associated with the data transfer.

11. The computer program product of claim 8, wherein the data transfer occurs across a plurality of regulatory bodies.

12. The computer program product of claim 8, wherein recording the data transfer within the distributed network system comprises identifiable information recorded into the distributed network system.

13. The computer program product of claim 8, wherein participants associated with the data transfer are sourced from outside the entity.

14. The computer program product of claim 8, wherein the data transfer comprises a resource transfer.

15. A computer-implemented method for leveraging a distributed network system for secure data transfers, the computer-implemented method comprising:
receiving a data transfer from an entity wherein the entity is at least partially implicated within the data transfer,
wherein the data transfer comprises participants associated with the data transfer;
recording the data transfer within a distributed network system, wherein the distributed network system comprises previous data transfers;
verifying identities of participants associated with the data transfer by retrieving documents recorded within the distributed network system associated with previous data transfers and participants within the data transfer;
verifying the data transfer complies with regulatory bodies associated with previously verified participants; and
triggering the data transfer between the participants upon successful verification of participants within the data transfer.

16. The computer-implemented method of claim 15, wherein the data transfer comprises a self-executing contract at least partially implicating participants associated with the data transfer.

17. The computer-implemented method of claim 15, wherein there are a plurality of participants associated with the data transfer.

18. The computer-implemented method of claim 15, wherein the data transfer occurs across a plurality of regulatory bodies.

19. The computer-implemented method of claim 15, wherein recording the data transfer within the distributed network system comprises identifiable information recorded into the distributed network system.

20. The computer-implemented method of claim 15, wherein the data transfer comprises a resource transfer.
